(19) United States
(12) Patent Application Publication
(10) Pub. No.: US 2007/0115955 A1
(43) Pub. Date: May 24, 2007

(54) System and apparatus for integration of equipment and communications

(76) Inventors: Charles C. Byer, Palo Alto, CA (US); Michael E. Wilmer, Portola Valley, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/590,117

(22) Filed: Oct. 31, 2006

Related U.S. Application Data
(60) Provisional application No. 60/731,847, filed on Oct. 31, 2005.

(51) Int. Cl. H04L 12/50; H04Q 11/00

(52) U.S. Cl. 370/360

(57) ABSTRACT

An integrated, modular equipment system including a communication component configured to allow voice and data communication, a navigation component configured to provide location and directional information, a central processor in communication with the communication component and the navigation component, the central processor comprising software for providing information about a user's surroundings, and a power source operatively connected to the central processor. The central processor, communication component, navigation component, and power source of the system are integrated into a stock of a weapon.

### PRIORITY CLAIM

This application claims the benefit of United States Provisional Patent Application having Ser. No. 60/731,847 filed on Oct. 31, 2005, entitled “System and Apparatus for Integration of Equipment and Communications”, the entire disclosure of which is incorporated herein by reference for all purposes.

### TECHNICAL FIELD

The present invention relates to an integrated modular equipment system, and more particularly relates to an integrated modular equipment system for a soldier.

### BACKGROUND

Existing integrated soldier-fighting systems are designed to enhance the effectiveness, battle-command compatibility, survivability, mobility, and sustainability of dismounted combat soldiers. Examples of such systems are described in U.S. Pat. No. 5,864,481, which include systems that integrate protective clothing, communications, sensors, and power to enhance soldier and fighting capabilities in a system that is generally designed to be worn close to the center of gravity of the wearer's body and be distributed between the shoulders and hips of the wearer.

In some systems that are currently available, several major components are positioned on a rucksack that is worn as a backpack having quick release straps that allow the system to be jettisoned easily and quickly. Each of the components are connected to each other and/or to a system control module via at least one cable and/or other connector. One disadvantage of this technology is that the components of such a system are numerous and the total weight is relatively high (e.g., about 80 to 85 pounds), which can make the system difficult to carry. Another disadvantage of some of these types of systems is that they require a number of cables or wire harnesses connected to the various components, which can become disconnected or damaged during movement of the system. Disconnection of the cables or wire harnesses can compromise the functioning of the system and possibly even the safety of the soldier. In addition, while quick removal of the rucksack is an important feature for the safety of the soldier in certain situations, such removal of the rucksack can result in loss of several components of the system, which again can compromise the safety of the soldier.

In another known system, the individual components such as the navigation, communications, user control, computer processing, and power source components are configured as separate modules that are mounted or positioned at various points on a soldier's uniform and equipment. Again, the modules are connected to each other and/or to a central processor by individual cables. One concern with this configuration is the risk of entanglement, disconnection, and/or damage of cables during battlefield conditions. That is, there is a risk that a user and others that come in contact with the user, such as a soldier, might become entangled in or be tripped by the cables during movement. In addition, these cables can become entangled with branches or other obstructions when performing normal soldier activities. One example of such a system 100 is illustrated in FIG. 1, which generally includes, in part, a remote input pointing device (“RIPD”) 102, a thermal weapon system 106, and an audio headset 114. The system 100 further includes a cable 110 connecting the RIPD 102 to a junction block 112, a wire harness 104 connecting the weapon system 106 to the junction block 112, and a wire harness 108 connecting the audio headset 114 to the junction box 112. Thus, this subset of three components of the entire system described relative to system 100 requires multiple cables or wire harnesses. In general, these cables or wire harnesses are selectively connectable to and removable from the components as desired (i.e, the cables are not typically hard-wired to their respective components).

Since the system 100 may further include a number of additional components, such as a compass, video camera, lights, and the like, a complete system would require even more cables or wire harnesses than described relative to system 100. Each of these cables adds additional complexity to the system and introduces another component that can malfunction. or become disconnected from the system. Yet another drawback to these systems is that each of the separate components may require an individual protective shell to shield each one from electromagnetic fields. The requirement of separate shells for each module results in added weight, bulk, and encumbrance associated with the system. Thus, there is a need to provide improved systems and apparatuses for integration of equipment and communications for use by soldiers in a compact and mobile system.

### SUMMARY

The present invention relates to an integrated modular equipment system, including, according to one embodiment of the invention, an integrated combat and communications equipment system. The integrated system of the invention includes several components that are sized and positioned for ease of use. In comparison to many existing systems, the system of the present invention is a smaller, lighter system and thus is easier to carry. According to one embodiment, the entire system has dimensions similar to that of a typical personal digital assistant (“PDA”). The reductions in size and mass reduce the need for designing solutions to the significant problems of shock and environmental protection for the various components in the existing technology.

According to one embodiment in which the system of the present invention is used for military purposes, the system can be positioned in or integrated with the stock of a rifle or similar weapon, thereby reducing the amount of material needed to make and protect the system and eliminating the need for the removable connection components required for the existing systems. Given the importance to a soldier of his or her rifle, the additional advantage of integrating the system into the stock of a rifle or other weapon is the unlikelihood of the system being lost or misplaced.

In one aspect of the invention, an integrated, modular equipment system is provided, the system comprising a communication component configured to allow voice and data communication, a navigation component configured to provide location and directional information, a central processor in communication with the communication component and the navigation component, the central processor comprising software for providing information about a user's surroundings, and a power source operatively connected to the central processor. The central processor, communication component, navigation component, and power source of the system are integrated into a stock of a weapon.

In another aspect of the invention, a handheld weapon is provided, the weapon comprising a barrel and a stock adjacent to the barrel, the stock comprising an integrated communications and equipment system. The integrated communications and equipment system comprises a communication component configured to allow voice and data communication, a navigation component configured to provide location and directional information, and a computer in communication with the communication component and the navigation component and comprising software configured to provide information about a user's surroundings.

### BRIEF DESCRIPTION OF THE DRAWINGS

The present invention will be further explained with reference to the appended Figures, wherein like structure is referred to by like numerals throughout the several views, and wherein:

FIG. 1 provides a front view of a prior art embodiment of an multi-component system;

FIG. 2 is a perspective view of a portion of a weapon including an integrated modular equipment system of the invention;

FIG. 3 is a side view of an integrated modular equipment system of the invention; and

FIG. 4 is a side view of an integrated modular equipment system of the invention.

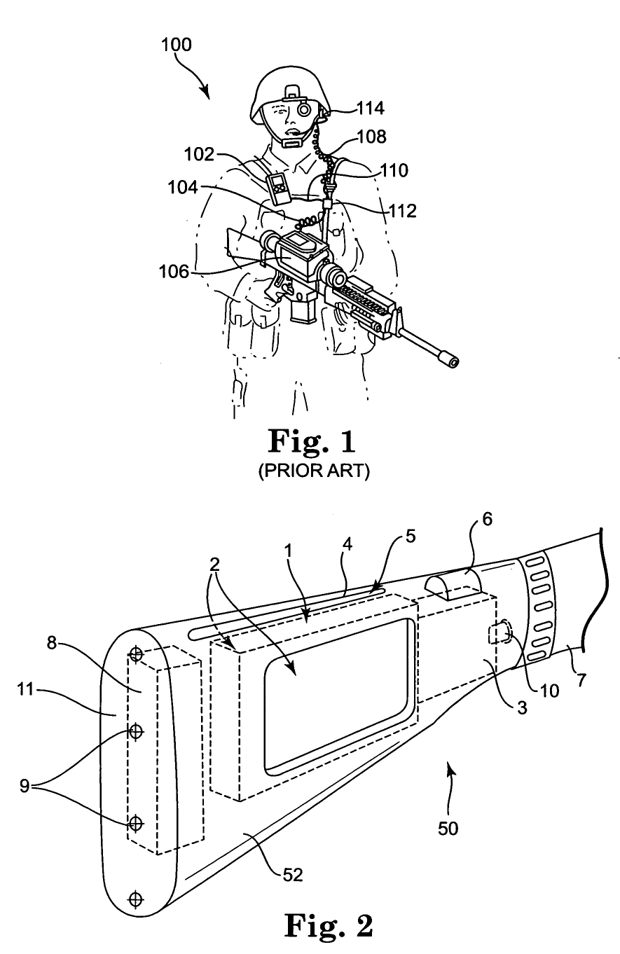

### DETAILED DESCRIPTION

Referring now to the Figures, wherein the components are labeled with like numerals throughout the several Figures, and initially to FIG. 2, an integrated modular equipment system 50 is illustrated, according to one embodiment of the invention. In this embodiment, the system 50 is integrated into the stock 52 of a weapon, such as a rifle. In general, integrated modular equipment system 50 includes a processor module 1, which comprises a communications module, a navigation module and a central processing unit (“CPU”). The system 50 further includes a display 2, which can be integrated into the side weapon stock 52 so that it is generally flush with the surface of the weapon stock 52, although it may be slightly recessed or slightly raised relative to the surface of the weapon stock 52. The display 2 may be provided for viewing from only one side of the weapon stock, or the display 2 may instead be two-sided, allowing it to be viewed from either side of the weapon stock. The two-sided display 2 may advantageously provide additional flexibility for the user to choose which side of the weapon stock to view for information, and may better accommodate both right and left handed users of the system. However, because some users may prefer to view only one side of the weapon stock, if a two-sided display 2 is provided, the system 50 may also be provided with a mechanism for controlling whether one or both sides of the display are turned on, since using only one side of the display may help to conserve battery power.

As described above, the display 2 may be two-sided, which can be accomplished by providing a single unit that is integrated into the stock 52 of a weapon, with the unit itself having two sides with a display panel or surface. Alternatively, a two-sided display may consist of two separate display units that are positioned adjacent to each other and facing in opposite directions within the stock 52 of a weapon. These two units can be integrated with each other within the stock 52, either with a physical connection or a wireless connection.

In one embodiment of the system 50, the display 2 on one or both sides of the stock 52 can be coverable by a door or cover 3 that can be used to expose and hide the display(s) 2 as desired. There may also be switches or other components (e.g., switch 10) associated with each door 3 to control the power for the display(s) 2. That is, closing one of the doors 3 can cover and protect its corresponding display 2 and can also turn the power to the display 2 off, such as by putting the display 2 into a standby mode, thereby conserving battery power for the system 50. The display(s) 2 can provide the same or similar information to a user as the optical display in the existing helmet subsystem of prior art systems, or may provide more, less, or different information than known systems.

If a system 50 is provided with a two-sided display 2, both sides may provide the same information in the same format. Alternatively, each of the displays 2 may provide different information and/or provide the information in a different format. In any case, one or both of the displays can be a digital display, a video graphics array (“VGA”) display, or any of a wide variety of different display formats. The display 2 may be provided as a monochromatic display, or the display can include a number of colors.

In operation, the incorporation of two displays 2, with one display on each side of the stock 52, allows the system 50 to be operated in a right- or left-handed mode. Opening the sliding door on either side can activate the switch 10 that activates the appropriate left or right display. When both the doors are closed, the system can be in a power save mode, with only radio and GPS update functions running on the processor, for example.

According to one exemplary embodiment of the invention, one or more of the following components may be formed or molded into the weapon stock 52: a radio communications antenna 4, one or more global positioning system (“GPS”) antennas 6, an interface 7 (via cable) to the Weapon User Input Device (“WUID”), and a wireless interface 5 to an audio headset (not shown). According to one embodiment, the wireless technology can be of the type provided under the trade designation “Bluetooth” or similar technology. The audio components can be retained in the helmet subsystem, according to one embodiment, while all other components, such as those listed above, are integrated into the weapon itself.

The display 2 is preferably provided to allow the system to be operated in a right- or left-handed mode. In this way, a soldier will have the flexibility to shoot around a right- or left-hand corner. By positioning the display on the right side of the weapon, the operator can shoot around a right-hand corner. Alternatively, by positioning the display on the left side of the weapon, the operator can shoot around a left-hand corner. When the display is docked in its stable carrying position, the system according to one embodiment can be in a power save mode, with only radio and GPS update functions running on the processor. In operation, the use of a flexible cable-mounted display embodiment allows the display to be moved from its stable carrying position in contact with the upper edge of the weapon stock, thereby activating the display.

The system 50 may further comprise a battery pack 8 that is rechargeable. As shown, the battery pack 8 is nested under the butt plate 11 of the stock 52 of the weapon, although it may be positioned in another location that does not interfere with the user's operation or maneuvering of the weapon. The battery pack 8 may include one or more battery charging contacts 9 through which the battery pack 8 may be recharged while it is in the weapon, although it is desirable that the battery pack 8 may also be relatively easy to remove for replacement thereof. In any case, the battery charging contacts 9 can be built into the stock (e.g. at the butt plate 11) to facilitate charging of the battery when the user is in a vehicle such as a Bradley or Stryker vehicle or at another location where electricity is available. In one aspect of the invention, a weapon containing a system of the present invention can be placed on a weapons rack that provides an electrical connection or connections that can be inserted into the battery charging contacts 9.

In an alternative embodiment of the invention, the integrated modular equipment system need not have a display. For example, it might be desirable to only provide displays to certain users, such as, for example, squad leaders. The present invention contemplates, in one embodiment, a system that does not use the displays, but includes the radio, audio, friendly fire avoidance, and GPS functionality as described herein in single module that is enclosed in the stock of a weapon. If no display is provided with a system of the invention, a different type of visual, audio, tactile, or other type of communication may be provided, such as an audible warning tone or a vibratory signal.

In order to reduce the size of the hubs and/or electronic modules that are currently available, optional custom personalized chips can be used in the equipment systems of the present invention. These chips can miniaturize modules using packaging techniques for reducing component size. Some of the components that can be miniaturized for use in the systems of the invention include the processor module, memory storage devices, GPS's, and wireless radio chips, along with devices that can be placed within the stock of a weapon for determining the direction the weapon is pointing (e.g., a compass, an inclinometer, and the like).

In accordance with one aspect of the present invention, the assembled device can be made to fit in a stock suitable for attachment to a standard military rifle, as depicted in FIG. 2. In addition, various antennas can be included and molded into the stock 52 of the weapon, as desired.

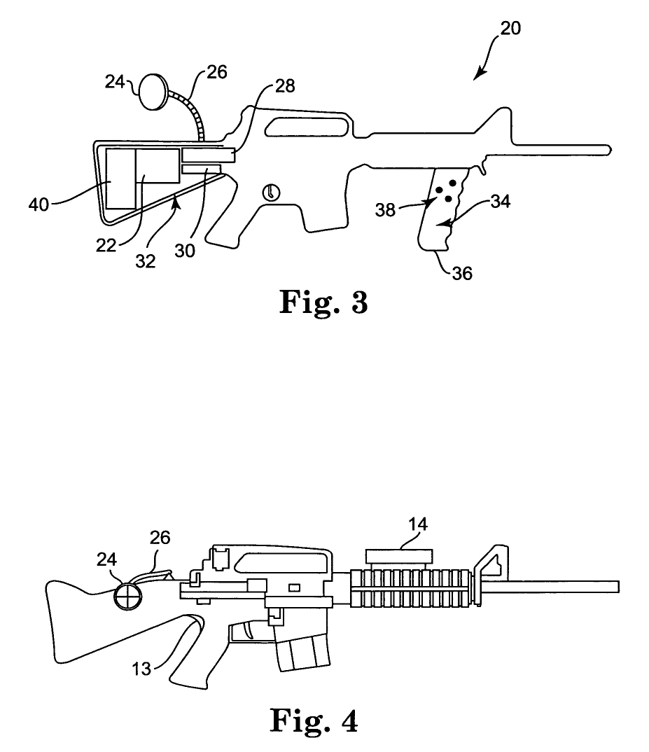

FIG. 3 depicts an integrated modular equipment system 20 in which the system is integrated into the stock of a weapon, according to another exemplary embodiment of the present invention. The system 20 includes a processor module 22 that houses the communications module, navigation module and CPU. The system 20 has a display 24 coupled to the weapon stock. In one aspect of the invention, the display 24 is a monocular display. The display 24 is, according to one embodiment, mounted on a flexible arm 26, such as an armored-type cable. The arm 26 can, in one aspect of the invention, contain or have integrated therein wires, conductors, or other electronic connectors and can also provide support and stability for the display 24, thereby allowing it to be repositioned such that it can be viewed from either side of the weapon stock. As with the two-sided display depicted in FIG. 2, this display 24 of system 20 can be used as a replacement for the optical display in the existing helmet subsystem as disclosed in U.S. Pat. No. 5,864,481. In any case, display 24 can be a digital display, a video graphics array (“VGA”) display, or any of a wide variety of different display formats. The display 24 may be provided as a monochromatic display, or the display can include a number of colors.

According to the embodiment illustrated in FIG. 3, the weapon stock includes the following modules or components: a compass and inclinometer component 28, a radio frequency (“RF”) amplifier 30 and RF antenna 32, a WUID 34 integrated into the front hand grip 36, the WUID 34 including user input buttons 38, and a battery pack 40. According to another embodiment, the system depicted in FIG. 3 could also include components such as a communications component, a GPS antenna, and an interface to the WUID (not shown).

Referring now to FIG. 4, in order to ensure reliability, any cabling can be molded or otherwise integrated into the stock and routed as necessary along the action to the WUID location, which could be, for example, aft of the trigger housing 13 and to any sighting device 14 mounted on the weapon.

The sighting device 14, in one embodiment, is an infrared sight device. Alternatively, the device can be a daylight video sight (“DVS”), or the device could utilize thermal weapon sighting technology. In a further alternative, the sighting device is any known sighting apparatus for use with a weapon. In one aspect of the invention, two or more sighting devices are simultaneously mounted on the weapon, wherein any of the mounted devices can be chosen by the user for operation. For example, the user can selectively activate the system of the present invention to show the image in the display provided by the desired sighting device. In one aspect of the invention, those sighting devices not selected to provide the image can be placed by the system into standby mode to conserve power. In one embodiment, the WUID allows the user to toggle among several devices without removing his hand from his weapon.

An electronic compass and level (inclinometer) sensor can be integrated into the electronics of any of the systems of the invention. According to one embodiment, the system of the present invention utilizes the information from the electronic compass and level sensors along with gathered GPS data to automatically compute the aim point and field of fire of the weapon. According to one embodiment, the computation is performed by the CPU. In use, the aim point and field of fire information can be provided to the user for better use of the weapon. In one aspect of the invention, if other members of the user's team or force (“friendly forces”) in the field have GPS units and those units are or have been transmitting their position(s) (in the form of automatic location update messages, in one embodiment), the system of the present invention can compare the friendly force location information and the aim point and field of fire information and trigger a warning signal to alert the user when at least one friendly soldier is within the aim point or field of fire of the user's weapon.

In an alternative aspect of the invention, the system of the present invention can also transmit position information (such as, for example, position update messages) to provide the user's location information to other infantry forces, aircraft, vehicles, etc. This allows, for example, an aircraft or commanders at a command control center to determine precise troop locations to provide better support, avoid friendly fire, and speed up search and rescue missions and evacuation of wounded.

The systems of the present invention can have any, some, or all of the following, configured as described above or in other related configurations:
A. Computer system (PDA sized)
B. Display with protective doors or covers
   1. Available on either side or both sides of the stock to provide left-handed or right-handed display
   2. Electronic cover position (e.g., Hall Effect) sensors that can activate the appropriate screen
C. Display mounted on flexible arm
   1. May be a monocular display
   2. Flexible arm can have necessary components for operation of display
   3. Flexible arm can allow for repositioning display such that it can be viewed from either side of stock
D. Weapon-integral connections to weapon-mounted daylight or thermal imaging devices to enable indirect view firing of the weapon around either left hand or right hand corners or obstacles (using the appropriate display screen).
E. Weapon-integral connection to multi-function laser ranging device to enable target ranging using either direct or indirect view aiming of the weapon.
F. Navigation system including GRAM-SAASM GPS card of the type that is manufactured by Rockwell Collins of Cedar Rapids, Iowa for the military and in use on military GPS units
G. Radio/communications system, such as a miniaturized military radio
H. Radio/communications using WLAN (Wireless Local Area Network) radio using the Mesh Radio SW (IP), commercially available from PEMSTAR Inc. of Rochester, Minn.
I. Communications antenna(s)
J. GPS antenna(s)
K. System battery
L. Bluetooth (or other wireless technology) module and antenna
M. Cables, as required by design, which may be integrally connected to their respective components
N. A design of the system allowing its removal from the weapon stock for use on a stand-alone basis
O. Butt plate battery charging connector
P. Weapon rack for stationary use, which may include incorporation with an appropriate battery charging system for the weapon and connectors compatible with the weapon charging connectors
Q. A weapon rack incorporating a battery charging system that is compatible for use in a vehicle such as a Bradley or Stryker vehicle
R. An electronic compass and inclinometer (level sensor)
S. Electronic communications systems having the ability to communicate with aircraft, ships, vehicles, bases, command stations, and the like
T. A weapon user input device

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. An integrated, modular equipment system comprising:
(a) a communication component configured to allow voice and data communication;
(b) a navigation component configured to provide location and directional information;
(c) a central processor in communication with the communication component and the navigation component, the central processor comprising software for providing information about a user's surroundings; and
(d) a power source operatively connected to the central processor;
wherein the central processor, communication component, navigation component, and power source of the system are integrated into a stock of a weapon.

2. The system of claim 1, further comprising a display for providing at least one visual indicator of information determined by the central processor.

3. The system of claim 2, further comprising a sighting component operably coupled with the display.

4. The system of claim 2, wherein the display is integrated into the stock of the weapon for viewing from at least one side of the stock.

5. The system of claim 4, wherein the display is visible from first and second opposite sides of the stock.

6. The system of claim 1, further comprising a display and a sighting component operably coupled with the display, wherein the sighting component and display allow for indirect view firing of the weapon.

7. The system of claim 1, further comprising a display operably coupled with the central processor, wherein the display is configurable for displaying a topographical map indicating positions of predetermined objects.

8. The system of claim 7, wherein the predetermined objects are soldiers.

9. The system of claim 7, wherein the topographical map further indicates a position of the weapon in relation to the predetermined objects.

10. The system of claim 1, further comprising a ranging device operably coupled with the central processor to provide information to the user regarding target range.

11. The system of claim 1, further comprising a wireless audio component wirelessly coupled to the communication component.

12. The system of claim 11, wherein the wireless audio component is a headset.

13. The system of claim 1, further comprising an input device operably coupled with the central processor for accepting user input.

14. The system of claim 13, wherein the input device is operably coupled with the central processor by a physical connection.

15. The system of claim 14, wherein the physical connection is at least one of a wire and a cable.

16. The system of claim 13, wherein the input device is operably coupled with the central processor wirelessly.

17. A handheld weapon comprising:
(a) a barrel; and
(b) a stock adjacent to the barrel, the stock comprising an integrated communications and equipment system, the system comprising:
(i) a communication component configured to allow voice and data communication;
(ii) a navigation component configured to provide location and directional information; and
(iii) a computer in communication with the communication component and the navigation component, the computer comprising software configured to provide information about a user's surroundings.

18. The weapon of claim 17, further comprising a display integrated into the stock of the weapon for providing at least one visual indicator of information determined by the computer.

19. The weapon of claim 18, wherein the display is visible from first and second opposite sides of the stock.
